(19) United States
(12) Patent Application Publication
(10) Pub. No.: US 2021/0267841 A1
(43) Pub. Date: Sep. 2, 2021

(54) Personal Massaging Device

(71) Applicant: Donald Joseph McDonald, Mulberry, FL (US)

(72) Inventor: Donald Joseph McDonald, Mulberry, FL (US)

(21) Appl. No.: 16/805,106

(22) Filed: Feb. 28, 2020

(51) Int. Cl. A61H 15/00

(52) U.S. Cl. CPC A61H 15/00; A61H 2205/081; A61H 2205/04; A61H 2015/0014

(57) ABSTRACT

A massage device which allows a user to easily and effectively self-administer a neck and/or shoulder massage. The device includes a first post, a second post, a first base, a second base, a crossbar, and a foam roller. The crossbar is connected in between the first post and the second post. Additionally, the foam roller is rotatably mounted onto the crossbar so that the crossbar supports the weight of the user's head and neck while the user performs a foam rolling operation. That is, the foam roller rotates about the crossbar while the user performs the foam rolling operation. The first base and the second base are attached to the first post and the second post and support the massaging device in an orientation that facilitates performing the foam rolling operation.

### FIELD OF THE INVENTION

The present invention relates generally to massaging devices. More specifically, the present invention relates to a massaging device with a rotatably mounted foam roller.

### BACKGROUND OF THE INVENTION

Many people experience tension, aches, injuries, tightening, weakening, and pain in and around their neck and upper shoulders. Those who often suffer from these injuries and physical experiences can typically gain relief from a neck and/or shoulder massage. A massage applies pressure onto the exterior of the skin in order to physically unwind tense muscles, activate specific pressure points, promote blood flow, and promote relaxation and well-being all around. Even those who don't experience much discomfort, would likely still enjoy neck massages as well. The present invention delivers a satisfying deep, and/or soft penetrating tissue massage. One main advantage of the present invention is that any individual can administer a massage entirely by themselves. The present invention is a stand-alone device that does not require batteries or other electrical sources. Additionally, the foam roller used in the present invention acts as a myofascial release tool. Thus, promoting range of motion and overall wellness.

### BRIEF DESCRIPTION OF THE DRAWINGS

FIG. 1 is an isometric perspective view of the present invention.

FIG. 2 is a front view of the present invention.

FIG. 3 is a front view of the present invention with the fam roller removed.

FIG. 4 is a perspective view of the foam roller used in the present invention.

FIG. 5 is an exploded perspective view of the present invention.

### DETAIL DESCRIPTIONS OF THE INVENTION

All illustrations of the drawings are for the purpose of describing selected versions of the present invention and are not intended to limit the scope of the present invention.

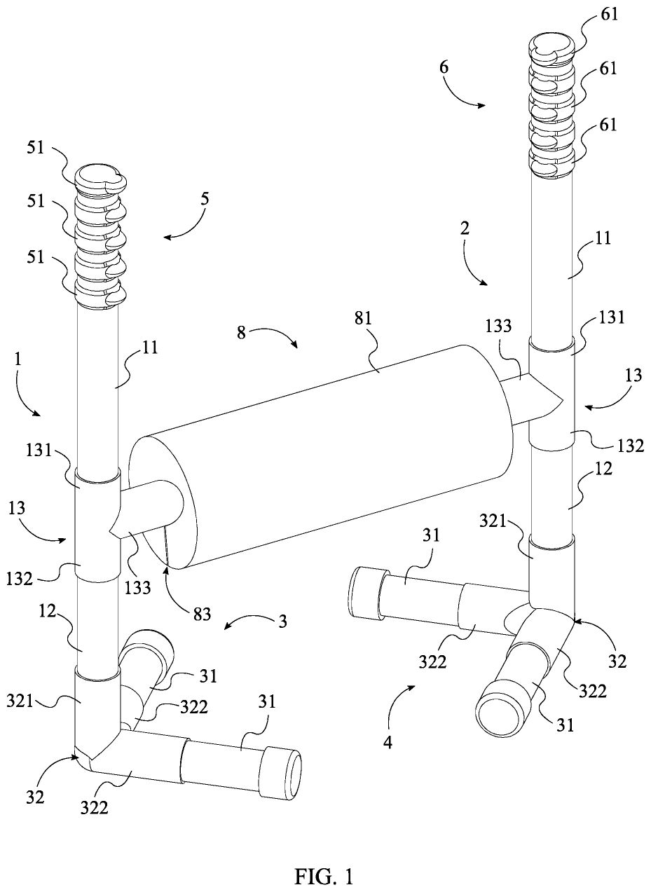

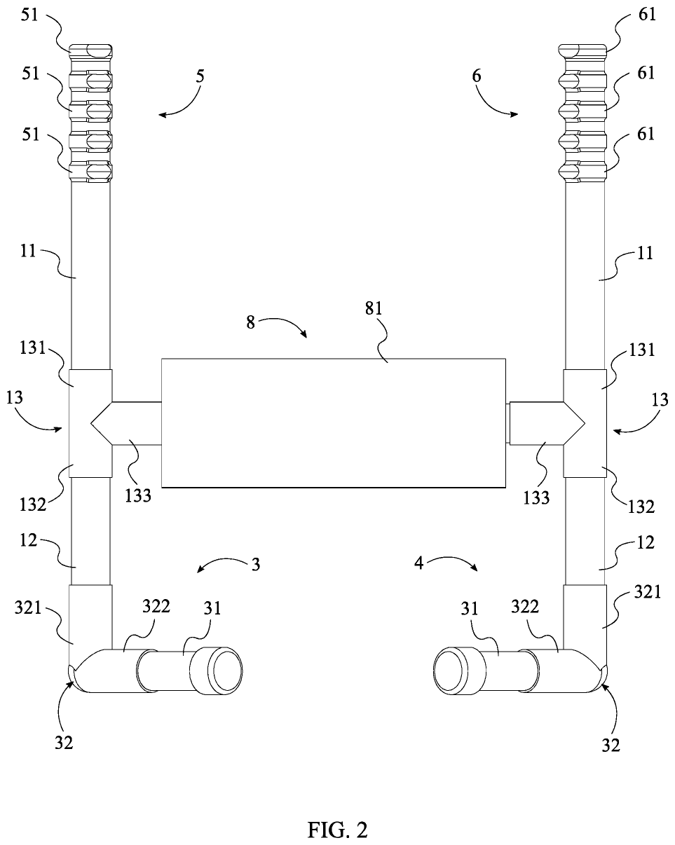

Referring to FIG. 1 through FIG. 5, in the preferred embodiment of the present invention, the personal massaging device is an apparatus that is designed to relieve tension and discomfort. To accomplish this, the present invention provides a frame and a foam roller. A user holds the frame in their hands and rolls the foam roller along the back of the neck. This enables the present invention to roll along the muscles of the neck, thereby increasing range of motion by circulating oxygenated blood through the tissues of the neck. Preferably, the user places the frame onto the ground and then rests the neck onto the foam roller. The user then moves in an oscillating pattern and rolls the foam roller along the muscles of the neck. To achieve this functionality, the present invention comprises a first support post 1, a second support post 2, a first base 3, a second base 4, a crossbar 7, and at least one foam roller 8. The first base 3 and the second base 4 are rigid stabilizers that enable the present invention to be retained in a desired orientation when mounted onto the ground or any other surface. The first base 3 is terminally attached to the first support post 1. Likewise, the second base 4 is terminally attached to the second support post 2. As a result, the first support post 1 and the second support post 2 function as risers that retain the crossbar 7 in a desired position. The crossbar 7 is connected in between the first support post 1 and the second support post 2. Additionally, the crossbar 7 is positioned offset from the first base 3 across the first support post 1. Likewise, the crossbar 7 is positioned offset from the second base 4 across the second support post 2. As a result, the crossbar 7 is suspended between the first support post 1 and the second support post 2. Moreover, the crossbar 7 is maintained in a position that facilitates supporting the user's neck. The foam roller 8 is rotatably mounted around the crossbar 7. Thus positioned, the foam roller 8 is able to rotate about the crossbar 7 as the user employs the present invention for massaging operations.

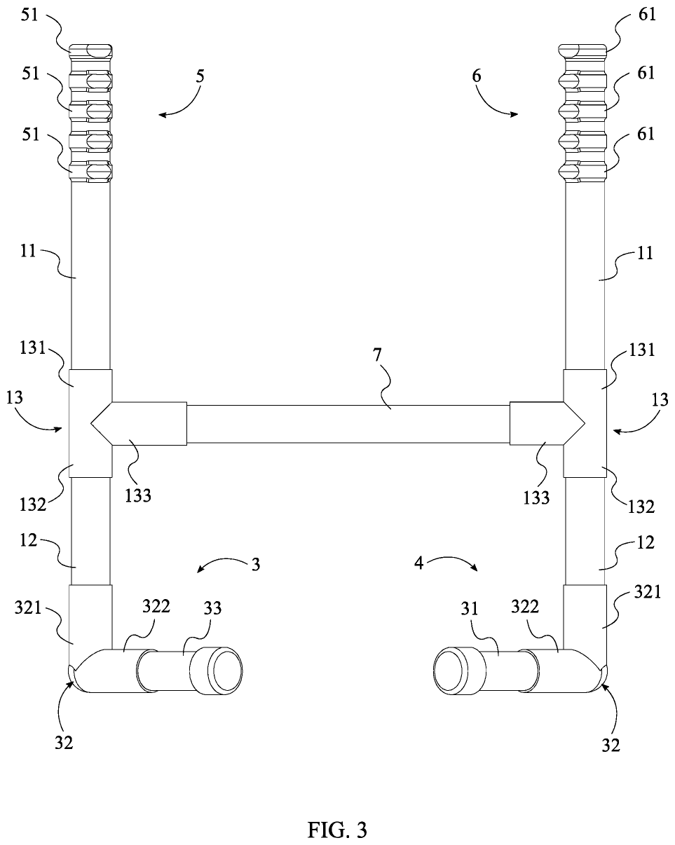

Referring to FIG. 3, some embodiments of the present invention are designed to function as collapsible systems. To that end, first support post 1 and the second support post 2 each comprise a first post 11, a second post 12, and an intermediary post connector 13. The intermediary post connector 13 acts as a coupling joint between the components of the first support post 1, the second support post 2, and the crossbar 7. Specifically, the first post 11 is terminally attached the intermediary post connector 13. Additionally, the second post 12 is terminally attached the intermediary post connector 13. Further, the second post 12 is positioned opposite to the first post 11, across the intermediary post connector 13. Thus positioned, the intermediary post connector 13 enables the first support post 1 and the second support post 2 to form linear risers that maintain the crossbar 7 in a desired position. Relatedly, the crossbar 7 is terminally attached to the intermediary post connector 13 of the first support post 1. Similarly, the crossbar 7 is terminally attached to the intermediary post connector 13 of the second support post 2. Thus, the intermediary post connector 13 of the first support post 1 and the intermediary post connector 13 of the second support post 2 enable the present invention to be assembled into a free-standing frame or disassembled into a collection of connectors and support members. In some embodiments, a rotating coupler is integrated into the intermediary post connector 13 such that the crossbar 7 is rotatably connected to the intermediary post connector 13 of the first support post 1 and the intermediary post connector 13 of the second support post 2.

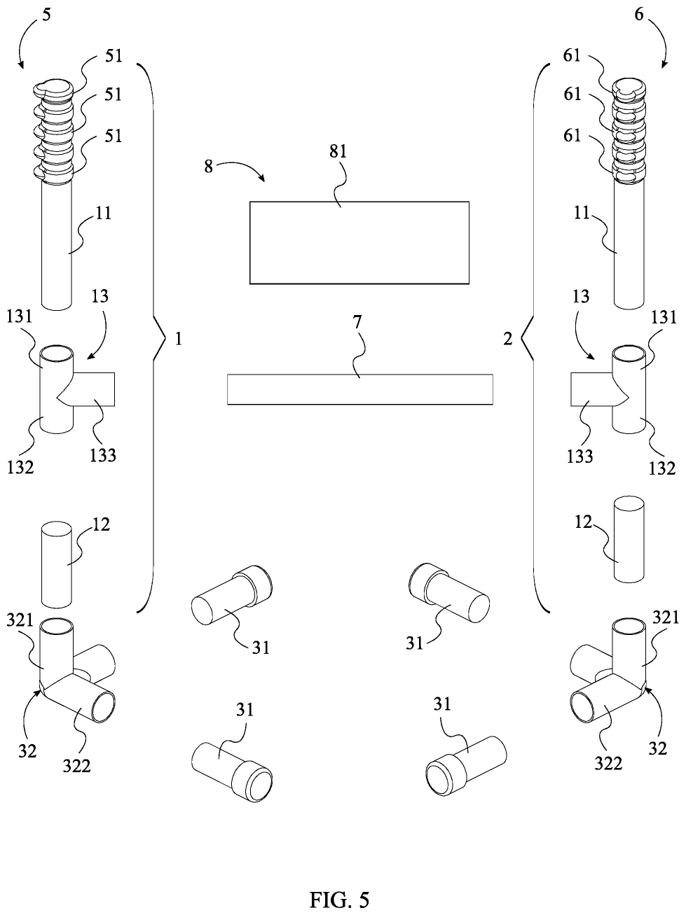

Referring to FIG. 1 and FIG. 5, expounding on the collapsible nature of the present invention, the intermediary post connector 13 comprises a first post coupler 131, a second post coupler 132, and a third post coupler 133. The first post coupler 131, the second post coupler 132, and the third post coupler 133 are receptacles used to mate to the end of the first post 11, the second post 12 and the crossbar 7. Additionally, second post coupler 132 is connected adjacent to the first post coupler 131 and is linearly aligned to the first post coupler 131. The third post coupler 133 is connected in between the first post coupler 131 and the second post coupler 132 and is oriented perpendicular to the first post coupler 131 and the second post coupler 132. Accordingly, the intermediary post connector 13 is formed into a T-shaped coupling mechanism that retains the first post 11, the second post 12, and the crossbar 7 in a fixed relationship, relative to each other. Specifically, the first post 11 engages into the first post coupler 131, the second post 12 engages into the second post coupler 132, and the crossbar 7 engages into the third post coupler 133. Thus, a first end of the crossbar 7 is engaged into the intermediary post connector 13 of the first support post 1 and a second end of the crossbar 7 is engaged into the intermediary post connector 13 of the second support post 2 to form an H-shaped frame. In an alternative embodiment of the present invention, the first support post 1 and the second support post 2 are rigid beams to which the intermediary post connectors 13 are slidably attached. In this embodiment, the user is able to adjust the height of the crossbar 7 by sliding the intermediary post connectors 13 along the first support post 1 and the second support post 2.

Referring to FIG. 1 and FIG. 5, the first base 3 and the second base 4 are used to provide stable mounts for the first support post 1 and the second support post 2. To that end, the first base 3 and the second base 4 each comprise a plurality of legs 31, an intermediary base connector 32, and a plurality of caps. The intermediary base connector 32 is a fastening device. Additionally, each of the plurality of legs 31 is terminally attached to the intermediary base connector 32. Further, each of the plurality of legs 31 is angularly offset from one another. As a result, the intermediary base connector 32 forms the plurality of legs 31 into a base that resists being toppled. The intermediary base connector 32 of the first base 3 is connected in between the plurality of legs 31 of the first base 3 and the first support post 1. Likewise, the intermediary base connector 32 of the second base 4 is connected in between the plurality of legs 31 of the second base 4 and the second support post 2. Accordingly, the first base 3 and the second base 4 retain the first support post 1 and the second support post 2 in orientations that facilitate massaging the user's neck. Preferably, the first base 3 and the second base 4 each comprise two legs that are perpendicularly aligned. In a separate embodiment, the plurality of legs 31 is formed into a tripod.

Referring to FIG. 1 and FIG. 5, in some embodiments the intermediary base connector 32 comprises a support coupler 321 and a plurality of leg couplers 322. The support coupler 321 and the plurality of leg couplers 322 function similarly to the first coupler. Additionally, the plurality of leg couplers 322 is connected adjacent to the support coupler 321. Further, each of the plurality of leg couplers 322 is angularly offset from the support coupler 321. Finally, each of the plurality of legs 31 is terminally engaged into a corresponding coupler from the plurality of leg couplers 322. Accordingly, the plurality of leg couplers 322 form braces that hold the plurality of legs 31 in orientations that facilitate supporting the crossbar 7 in a desired orientation for rolling along the user's neck. Preferably, plurality of legs 31 is maintained in a V-shaped orientation where a plane created by the two legs is oriented perpendicular to a longitudinal axis of the first post 11 and the second post 12. Each of the plurality of caps is terminally mounted onto a corresponding leg 33 from the plurality of legs 31, opposite to the intermediary base coupler. Accordingly, the plurality of caps prevents the plurality of legs 31 from sliding across, or damaging, a surface on which the present invention rests.

Referring to FIG. 3, in addition to the prone position, the present invention is designed to be used while the user is in an upright position. To that end, the present invention further comprises a first handle 5, a second handle 6, a first plurality of ergonomic ridges 51 and a second plurality of ergonomic ridges 61. The first handle 5 is terminally mounted onto the first support post 1, opposite to the first base 3. Similarly, the second handle 6 is terminally mounted onto the first support post 1, opposite to the second base 4. Thus, the user is able to grasp the present invention and hold the crossbar 7 perpendicular to the user's neck. To expound on this functionality, the first plurality of ergonomic ridges 51 is laterally connected to the first handle 5 and distributed along the first handle 5. Similarly, the second plurality of ergonomic ridges 61 is laterally connected to the second handle 6 and distributed along the second handle 6. Thus positioned, the first plurality of ergonomic ridges 51 and the second plurality of ergonomic ridges 61 prevent the user's hand from slipping along the first handle 5 and the second handle 6 while rolling along the user's neck. In some embodiments, the present invention is constructed using pipes with diameters ranging from 0.25 inches to 1.5 inches.

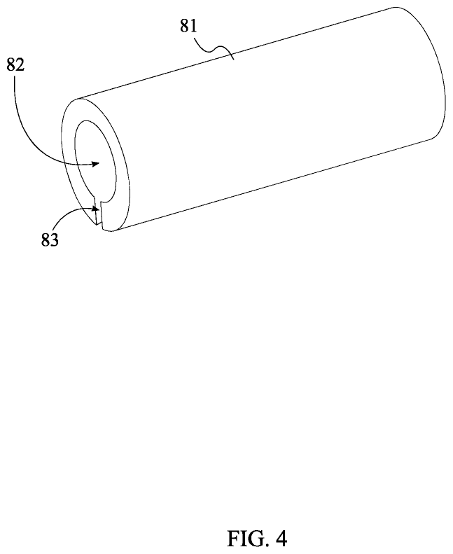

Referring to FIG. 4 and FIG. 5, preferably, the foam roller 8 is designed to be removed and replaced depending on the user's rolling needs. To that end, the foam roller 8 comprises a foam roll 81, a hole 82, and a slot. The hole 82 normally traverses through the foam roll 81 and is oriented along a longitudinal axis of the foam roll 81. Additionally, the slot laterally traversing through the foam roll 81 into the hole 82 and the crossbar 7 is rotatably engaged within the hole 82. As a result, the foam roll 81 can be mounted onto the crossbar 7 by sliding the crossbar 7 through the slot and nestling the crossbar 7 within the hole 82. Thus engaged, the foam roll 81 is able to rotate around the crossbar 7 when rolling. Preferably, the foam roller 8 can be manufactured with a variety of textured exteriors. Each textured exterior can be used to perform different types of foam rolling operations. Some embodiments of the present invention include handheld massage tools that can be pressed against various body parts.

Although the invention has been explained in relation to its preferred embodiment, it is to be understood that many other possible modifications and variations can be made without departing from the spirit and scope of the invention as hereinafter claimed.

What is claimed is:

1. A personal massaging device comprising:
at least one first support post;
at least one second support post;
at least one first base;
at least one second base;
at least one crossbar;
at least one foam roller;
the first base being terminally attached to the first support post;
the second base being terminally attached to the second support post;
the crossbar being connected in between the first support post and the second support post;
the crossbar being positioned offset from the first base across the first support post;
the crossbar being positioned offset from the second base across the second support post; and
the foam roller being rotatably mounted around the crossbar.

2. The personal massaging device as claimed in claim 1 comprising:
the first support post and the second support post each comprising a first post, a second post, and an intermediary post connector;
the first post being terminally attached the intermediary post connector;
the second post being terminally attached the intermediary post connector;
the second post being positioned opposite to the first post, across the intermediary post connector;
the crossbar being terminally attached to the intermediary post connector of the first support post; and
the crossbar being terminally attached to the intermediary post connector of the second support post.

3. The personal massaging device as claimed in claim 2 comprising:
the intermediary post connector comprising a first post coupler, a second post coupler, and a third post coupler;
the second post coupler being connected adjacent to the first post coupler;
the second post coupler being linearly aligned to the first post coupler;
the third post coupler being connected in between the first post coupler and the second post coupler;
the third post coupler being oriented perpendicular to the first post coupler and the second post coupler;
the first post engaging into the first post coupler;
the second post engaging into the post second coupler; and
the crossbar engaging into the third post coupler.

4. The personal massaging device as claimed in claim 1 comprising:
the first base and the second base each comprising a plurality of legs and an intermediary base connector;
each of the plurality of legs being terminally attached to the intermediary base connector;
each of the plurality of legs being angularly offset from one another;
the intermediary base connector of the first base being connected in between the plurality of legs of the first base and the first support post; and
the intermediary base connector of the second base being connected in between the plurality of legs of the second base and the second support post.

5. The personal massaging device as claimed in claim 4 comprising:
the intermediary base connector comprising a support coupler and a plurality of leg couplers;
the plurality of leg couplers being connected adjacent to the support coupler;
each of the plurality of leg couplers being angularly offset from the support coupler; and
each of the plurality of legs being terminally engaged into a corresponding coupler from the plurality of leg couplers.

6. The personal massaging device as claimed in claim 4 comprising:
the first base and the second base each comprising a plurality of caps; and
each of the plurality of caps being terminally mounted onto a corresponding leg from the plurality of legs, opposite to the intermediary base coupler.

7. The personal massaging device as claimed in claim 1 comprising:
a first handle; and
the first handle being terminally mounted onto the first support post, opposite to the first base.

8. The personal massaging device as claimed in claim 7 comprising:
a first plurality of ergonomic ridges;
the first plurality of ergonomic ridges being laterally connected to the first handle; and
the first plurality of ergonomic ridges being distributed along the first handle.

9. The personal massaging device as claimed in claim 1 comprising:
a second handle; and
the second handle being terminally mounted onto the second support post, opposite to the second base.

10. The personal massaging device as claimed in claim 9 comprising:
a second plurality of ergonomic ridges;
the second plurality of ergonomic ridges being laterally connected to the second handle; and
the second plurality of ergonomic ridges being distributed along the second handle.

11. The personal massaging device as claimed in claim 1 comprising:
the foam roller comprising a foam roll; a hole, and a slot;
the hole normally traversing through the foam roll;
the slot laterally traversing through the foam roll into the hole; and
the crossbar being rotatably engaged within the hole.
